(19) United States
(12) Patent Application Publication
(10) Pub. No.: US 2004/0203166 A1
(43) Pub. Date: Oct. 14, 2004

(54) Electrolysis apparatus and method utilizing at least one coiled electrode

(76) Inventor: John Timothy Sullivan, Marriottsville, MD (US)

Correspondence Address: BACON & THOMAS, PLLC, 625 SLATERS LANE, FOURTH FLOOR, ALEXANDRIA, VA, 22314

(21) Appl. No.: 10/411,316

(22) Filed: Apr. 11, 2003

(51) Int. Cl. G01N 21/00

(52) U.S. Cl. 436/161; 436/164; 422/82.05; 422/70

(57) ABSTRACT

An electrolysis apparatus includes at least two coaxially spaced electrodes, at least one of which is a coil. Currents in the coil generate a magnetic field to accelerate the electrolysis process.

### BACKGROUND OF THE INVENTION

1. Field of the Invention

This invention relates to an electrolysis apparatus and method, and particularly to an apparatus for and a method of generating hydrogen and oxygen by water electrolysis.

In its broadest form, the invention involves the application of a magnetic field to an electrolytic medium, in a direction generally transverse to the direction of ionic currents induced in the medium by oppositely charged electrodes, in order to increase the rate at which molecules of the electrolytic medium dissociate in response to the ionic currents.

According to a narrower aspect of the invention, the apparatus of the invention is characterized by a plurality of electrodes, at least two of which are coaxial, and at least one of the coaxial electrodes forms a coil. When a DC voltage is applied to the coil, a magnetic field is generated that accelerates the electrolysis process.

Although especially suitable for water electrolysis, the apparatus of the invention may be used in other electrolytic processes. In the case of water, the apparatus of the invention substantially increases the rate of dissociation of the water molecules even without the addition of catalysts such as KOH, enabling the provision of compact, inexpensive, battery-powered hydrogen generators that run on ordinary tap water or water from natural sources such as lakes and rivers. If sunlight is used to further accelerate hydrogen generation, it is even possible to generate sufficient hydrogen to operate a fuel cell capable of generating more electricity than is required to sustain the electrolysis process.

In addition, one or both of the at least two coaxial electrodes may be encapsulated to separate the generated hydrogen and oxygen, according to the principles disclosed in copending U.S. patent application Ser. No. 10/xxx,xxx of John Timothy Sullivan, filed concurrently herewith and entitled “Apparatus For And Method Of Generating And Using Multi-Directional DC and AC Electrical Currents,” incorporated herein by reference. Alternatively, the two coils may be formed by placing at least two coaxial electrodes in a flexible hose that itself is coiled, and that includes a pump at one end and gas outlets at the other end.

In one preferred embodiment of the invention, the DC voltage applied to the at least two coaxial electrodes is a conventional, steady-state DC voltage, while in a second preferred embodiment of the invention, the DC voltage is an alternating or reverse alternating multi-directional DC voltage, or a polarity reversing AC voltage, of the type disclosed in the above-identified copending U.S. patent application Ser. No. 10/xxx,xxx. It is also possible to apply pulsed DC, polarity reversing DC, and conventional AC voltages to the coiled electrode apparatus of the invention.

In the case of alternating or reverse alternating DC voltages, or direction-reversing AC voltages, which are applied to opposite ends of the electrodes, the apparatus and method of the invention has the advantage of a reduced voltage drop relative to the voltage drop found in electrodes connected at just one end. The same advantage may be obtained in the case of DC, pulsed DC, polarity reversing DC, and AC voltages if the voltages are applied to two ends of the electrodes rather than just one end.

2. Description of Related Art

It has long been known that application of a DC current or voltage to electrodes immersed in an electrolytic medium will cause useful reactions to occur in the medium. When the medium is water, the electrolytic process can be used to generate hydrogen and oxygen.

Recently, there has been an increase in interest in the generation of hydrogen for use in pollution-free hydrogen-driven power sources. Hydrogen fuel cells, in particular, are portable and efficient enough to replace fossil fuels in a wide variety of contexts, including vehicles. Unfortunately, the only commercially viable way to generate hydrogen is, at present, extraction of the hydrogen from fossil fuels, which generates pollution, requires a relatively high energy input relative to the energy value of the hydrogen produced, and requires a relatively high cost distribution system to ensure safety.

It has, of course, long been known that generation of hydrogen by water electrolysis is a potential alternative to fossil fuel extraction, with the significant advantage that water electrolysis can be carried out in situ, eliminating distribution problems. Nevertheless, all previous efforts to increase the efficiency of water electrolysis, to the point where it presents a viable source of hydrogen for fuel cells and other hydrogen-powered devices, have failed.

So-called regenerative electrochemical cell or systems in which the output of a hydrogen fuel cell is used to generate hydrogen by electrolysis, for example as disclosed in U.S. Published Patent Application No. 2002/0051898, do not yet offer a practical alternative to systems that burn fossil fuels. In order to attain widespread acceptance of regenerative electrochemical cells or systems, which have the potential to not only conserve energy and decrease pollution in industrialized countries, but also to provide a much needed low-cost source of energy for portable generators and vehicles in third world countries, and therefore alleviate such problems as extreme poverty and war, it is critical that the efficiency of water electrolysis systems be increased.

Since it is possible to significantly increase the rate of hydrogen production by adding sunlight, as disclosed for example in U.S. Published Patent Application No. U.S. 2002/0060161, it is possible that a hydrogen generator utilizing the principles of the invention can actually be made to generate sufficient hydrogen to power a fuel cell that outputs more energy than is required to generate the hydrogen, resulting in a source of hydrogen fuel that actually requires no energy input other than the sun. Furthermore, if alternating DC current is used, i.e., current which changes direction without changing polarity, the apparatus and method of the invention has the further advantage of sterilizing the water used as an electrolyte, providing a ready source of both energy and potable drinking water.

By way of background, U.S. Pat. No. 6,126,794 discloses use of a coil in connection with an electrolysis apparatus. However, the coil 104 of U.S. Pat. No. 6,126,794 is positioned above, and is in addition to, the electrodes used to carry out electrolysis, and the resulting magnetic field does not affect the dissociating water molecules, but rather causes the formation of parahydrogen and orthohydrogen from the hydrogen generated between the electrodes.

### SUMMARY OF THE INVENTION

It is accordingly a first objective of the invention to provide an apparatus and method for accelerating electrolysis processes in order to conserve energy resources and protect the environment.

It is a second objective of the invention to provide an apparatus and method which accelerates dissociation of molecules in an electrolyte, with or without the addition of catalysts.

It is a third objective of the invention to provide a simple, easily assembled, hydrogen generator that is also relatively lightweight, and that produces separate gasses which can be individually immediately utilized and/or stored at low power input and low overall total cost.

These objectives are achieved, in accordance with the principles of a preferred embodiment of the invention, by providing an electrolysis apparatus or cell having at least two coaxially spaced electrodes, at least one of which is in the form of a coil. Currents in the coil generate a magnetic field according to Lenz's law and the well-known right hand rule, and the resulting magnetic field accelerates the electrolysis process.

In an especially preferred embodiment of the invention, the electrolysis apparatus or cell is a hydrogen generator, and the electrodes are in the form of coaxial coils. A membrane or coating is positioned between the coils for reducing anode/cathode arcing, and producing separate gasses which can be immediately utilized and/or stored. The membrane or coating encapsulate the oppositely charged electrodes and allow the electrodes to be placed into intimate contiguous relationship with each other to thereby increase ion or electron conduction or flow, and correspondingly increase the generation of gasses. By way of example, the membrane could take the form of a sheet of flexible material impervious to gas bubbles but conductive to electron flow, or electrochemically conductive to ion flow and non-porous to gas bubbles, as disclosed in copending U.S. patent application Ser. No. 10/314,987 of John Timothy Sullivan, entitled “An Apparatus For Converting A Fluid Into At Least Two Gases Through Electrolysis,” filed on Dec. 10, 2002, and also incorporated herein by reference.

In an alternative preferred embodiment of the invention, instead of forming the electrodes into coils and placing them in a housing, the electrodes are in the form of coaxial tubes or wires separated by a gas impermeable membrane that permits passage of currents or ions between the electrodes. The electrodes are positioned in a flexible hose, which itself is coiled to provide a magnetic field generating electrolysis cell having an especially small footprint. In this embodiment, water is pumped through the coiled hose by means of a pump at one end, and gases are collected at the opposite end.

The electrodes may be supplied with either conventional, steady state, DC current, or alternating DC currents of the type described in copending U.S. patent application Ser. No. 10/xxx,xxx, also cited above. To achieve alternating DC currents, each end of at least one, and preferably both, of the electrodes is connected to a power supply in such a manner that the current direction in the electrode can be periodically or cyclically reversed.

The alternating DC current circuitry of this embodiment should not be confused with circuitry used in conventional electrolysis system to periodically reverse the polarity of the electrodes. Although it is possible to add switches to also periodically reverse the electrode polarity, such reversal would be in addition to the current reversal in the electrodes themselves, the electrodes being maintained at a constant polarity.

Reversal of currents in the electrodes has the effect of causing the current in the electrolyte to continuously change direction as it follows the EMF pulses resulting from current reversal, resulting in a multi-directional constant polarity current that has the effect of further accelerating electrolysis and, at the same time, scrubbing or reducing build up of electrolytic reaction products on the electrodes. Furthermore, when applied to an electrode in the form of a coil, the reversing currents create a magnetic vortex within the coil that adds to the energy available for dissociation of the water molecules.

Although less suitable for electrolysis, it is within the scope of the invention to apply voltages other than those noted above to the apparatus of the preferred embodiment. These include pulsed DC, polarity-reversing DC, and conventional AC voltages, as well as direction- reversing AC voltages of the type described in copending U.S. patent application Ser. No. 10/xxx,xxx, cited above. Where possible, it is also within the scope of the invention to apply the voltages to one end of the electrodes, although application to two ends is preferred since application to two ends reduces losses due to voltage drops within the electrodes.

The method of the invention involves the steps of providing at least one coil, and applying a voltage to the coil(s). The voltage may, as discussed above, be a constant DC voltage applied to one or both ends of the electrodes, a DC voltage alternately applied to opposite ends of the electrodes so as to cause reversal of currents in the electrodes, and therefore change in the direction of the current in the electrolyte, or other voltages depending on the particular application to which the coil is applied, and in particular on the nature of the magnetic fields to be generated. For example, the applied currents may be used to change the polarity and/or directions of the magnetic fields in either or both electrodes, either synchronously or non-synchronously, depending on the timing of current reversal, and whether the currents are reversed at the same or different ends.

### BRIEF DESCRIPTION OF THE DRAWINGS

FIG. 1 is a cross-sectional side view of a water electrolysis cell constructed in accordance with the principles of a preferred embodiment of the invention.

FIG. 2 is a cross-sectional side view of a variation of the embodiment of FIG. 1, in which each coil is surrounded by an electrical insulator to prevent arcing.

FIG. 3 is a cross-sectional side view of a further variation of the embodiment of FIG. 1, in which one of the coils is surrounded by a gas separation membrane, and in which both ends of each electrode are connected to a power supply.

FIG. 4, which appears with FIG. 1, is a schematic circuit diagram showing electrical connections of the electrolysis cell of FIGS. 1 and 2 to achieve alternating DC.

FIG. 5 is a cross-sectional side view of a variation of the electrolysis cell of FIG. 1, with just one coil.

FIGS. 6 and 7 are cross-sectional side views of variations of a second preferred embodiment of the invention, in which coaxial electrodes are situated in a flexible, coiled hose or tube.

FIG. 8 is an enlarged cross-sectional view of the hose and electrodes of FIGS. 6 and 7.

### DETAILED DESCRIPTION OF THE PREFERRED EMBODIMENTS

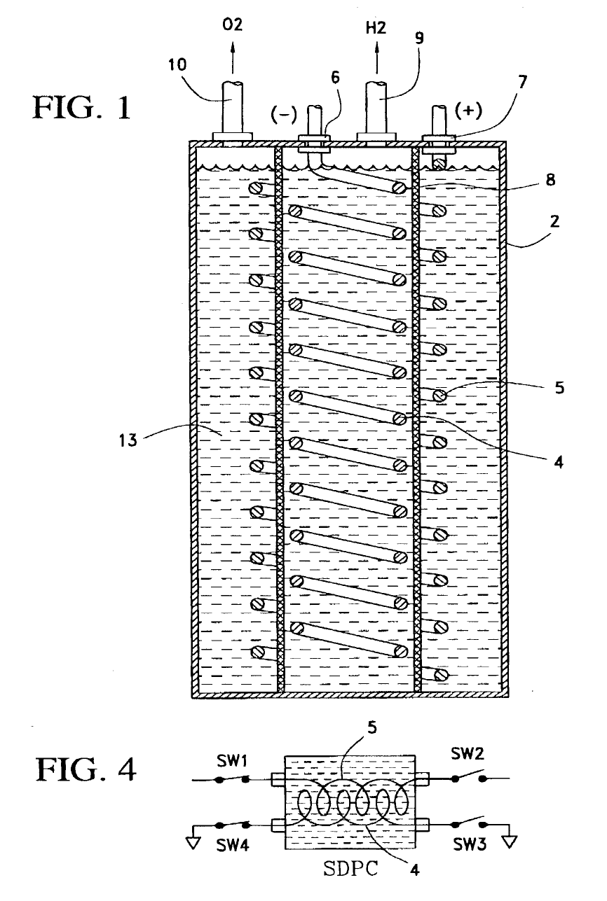

FIG. 1 illustrates an apparatus 1 which utilizes the principles of the invention to generate hydrogen and oxygen according to a first preferred embodiment of the invention. The apparatus 1 includes a tank or housing 2, two coaxial inner and outer electrodes 4,5, respectively, in the form of electrically conductive coils, connectors 6,7 for connecting the electrodes to a DC power source, such as a battery, and an electrode-encapsulating structure 8 surrounding the inner electrode 4. In addition, the apparatus 1 includes respective hydrogen and oxygen outlets 9 and 10, one or both of which are connected by pipes or hoses 11,12 to storage tanks, fuel cells, a combustion chamber(s), or the like for utilizing the generated gases.

As indicated above, the encapsulating structure 8 may be a sheet of flexible material that is impervious to gas bubbles but conductive to electron flow, or electrochemically conductive to ion flow and non-porous to gas bubbles, as disclosed in copending U.S. patent application Ser. No. 10/314,987, although it is within the scope of the invention to omit the encapsulating structure or encapsulation 8 and instead rely on more conventional methods of capturing the hydrogen and/or oxygen generated when DC voltages are applied to the electrodes.

Housing 2 of this embodiment may take any convenient form and, in addition, may be at least partially transparent to permit light enhanced electrolysis as described, for example, in U.S. Published Patent Application No. U.S. 2002/0060161.

Water 13 in this example is housed within the housing 2 and the encapsulation 8 and is bodily separated by the encapsulation 8. The water 13 may include a conventional catalyst such as potassium hydroxide (KOH), although the increased efficiency of the electrolysis process of the invention makes it possible to use ordinary tap water or water from rivers and lakes without adding additional catalysts.

Although the electrodes are illustrated as ordinary wires, it within the scope of the invention to use other electrode shapes. For example, the wire electrode could be flat rectangle or rounded, or have a variety of other shapes.

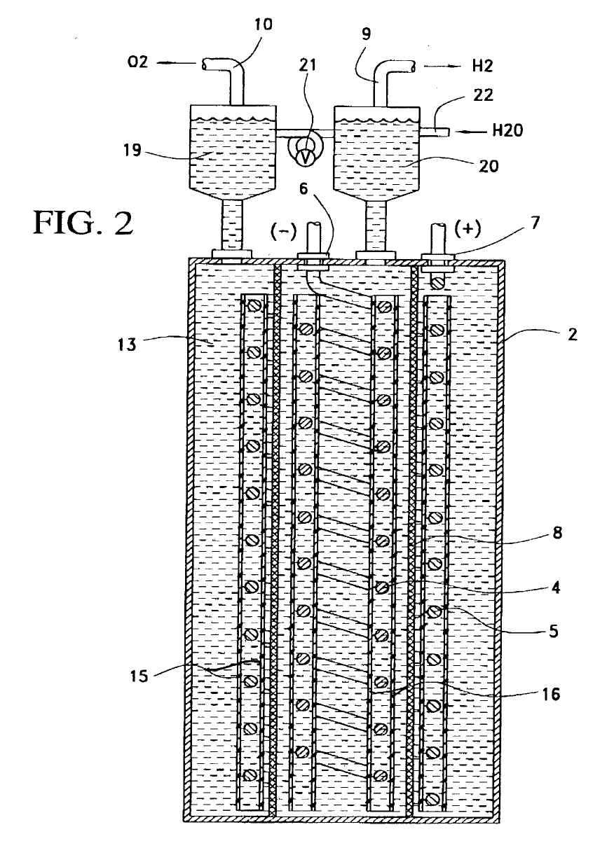

FIG. 2 shows a variation of the arrangement of FIG. 1, in which one or both of the respective coiled electrodes 4,5 are surrounded by a dielectric material to prevent arcing between the electrodes, and therefore to permit closer spacing and higher reaction rates. In the variation illustrated in FIG. 2, the dielectric material or insulating members are in the form of sleeves 15,15 and 16,16 surrounding and sandwiching therebetween the electrodes 5 and 4, respectively. In addition, the variation illustrated in FIG. 2 includes reservoirs 19 and 20 through which water is pumped by a pump 21 from an inlet 22 to replace water lost to electrolysis.

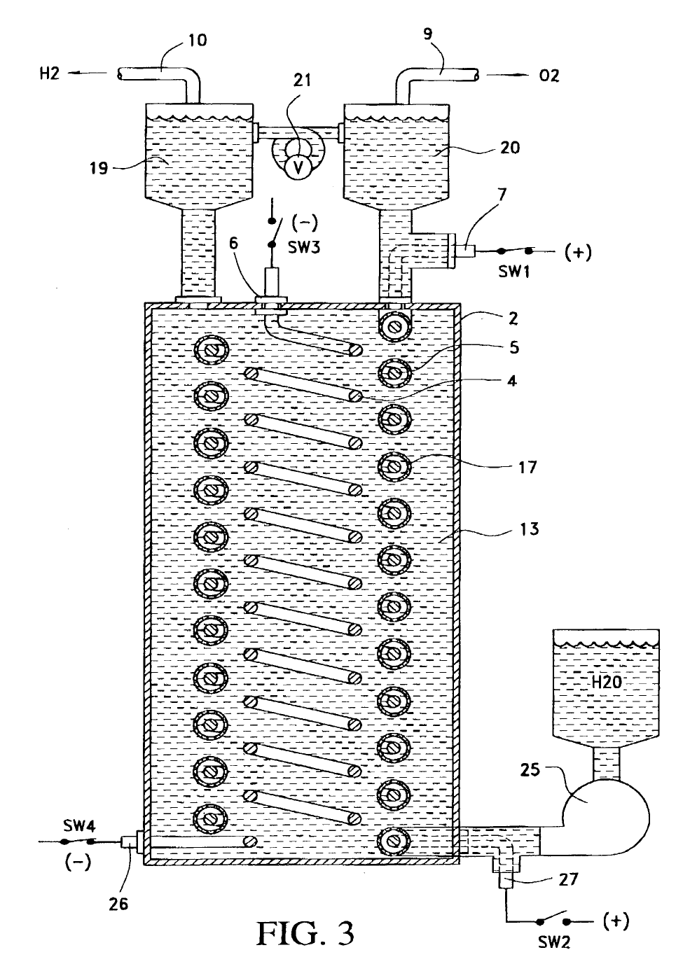

FIG. 3 shows a further variation of the embodiment of FIGS. 1 and 2, in which the gas separating member is in the form of a sleeve or tube 17 surrounding outer electrode 5 and coiled substantially coextensively with respect thereto. In this embodiment, water is pumped by an inlet pump 25 through the sleeve 17, through reservoir 20, pump 21, and reservoir and 19, and then into the main housing 2. This embodiment also includes additional electrical terminals 26 and 27, the purpose of which is to add a current-reversal circuit made up of switches SW1, SW2, SW3, and SW4, as illustrated in FIG. 4, or simply to prevent voltage losses in the electrodes, as explained in copending U.S. patent application Ser. No. 10/xxx,xxx, cited above. Of course, the specific configuration of the electrodes, membranes, insulators and so forth of each of the embodiments of FIGS. 1 and 3 is described by way of example only, and may be varied in a numerous ways without departing from the scope of the invention.

The reversing DC circuit of FIGS. 3 and 4 operates as follows: When switches SW1 and SW4 are closed, current flows from the positive electrode through switch SW1 to electrode 5. The current is then is carried by ions in the water 13 through the encapsulation or sleeve 17 to electrode 4, switch SW4, and ground or the negative terminal of a DC power supply (not shown). On the other hand, when switches SW2 and SW3 are closed current flows from the positive terminal of the power supply through switch SW2 into electrode 5, and then is carried by ions in the water through the sleeve 17 to electrode 4, through switch SW3, and finally back to ground or the negative terminal of the power supply. This causes the ionic current to change directions as it follows the electromagnetic pulses generated by the reversing currents, increasing the reaction rate. In addition, the currents in the two electrodes 4,5 generate oppositely directed magnetic fields. It will be appreciated by those skilled in the art that switches SW3 and SW4 could be interchanged to cause the negative currents to flow in the same direction as the positive currents, and therefore provide magnetic fields in the same direction. In either case, the fields shift position as they follow the incoming and reversing currents, creating a magnetic vortex that further accelerates disassociation of the water molecules.

It will be appreciated by those skilled in the art that there may be a delay between opening of switch pairs SW1,SW4 and closure of switch pairs SW2,SW3 and vice versa. In addition, the power sources and switching circuitry are not limited to batteries and switches, as described above, but rather may include any power sources and switching circuitry capable of effecting reversal of currents within the individual electrodes, including solid state switching circuitry and rectified AC power sources.

It will also be appreciated that the current-reversal circuit of FIG. 4 may also be applied to the electrolytic cells of FIGS. 1 and 2, and also that the current reversal circuit may be omitted from the electrolytic cell of FIG. 3 in favor of a conventional DC (or pulsed DC, polarity reversing DC, and even in certain circumstances conventional AC) power supply circuit.

The electrolytic reaction rate in each of the electrolytic cells illustrated in FIGS. 1-4 may be increased still further by applying light to the apparatus, so that the energy of the photons adds to the energy supplied by the electric fields between the electrodes and the magnetic fields within the electrodes, and the currents and/or fields may further be arranged to kill microorganisms.

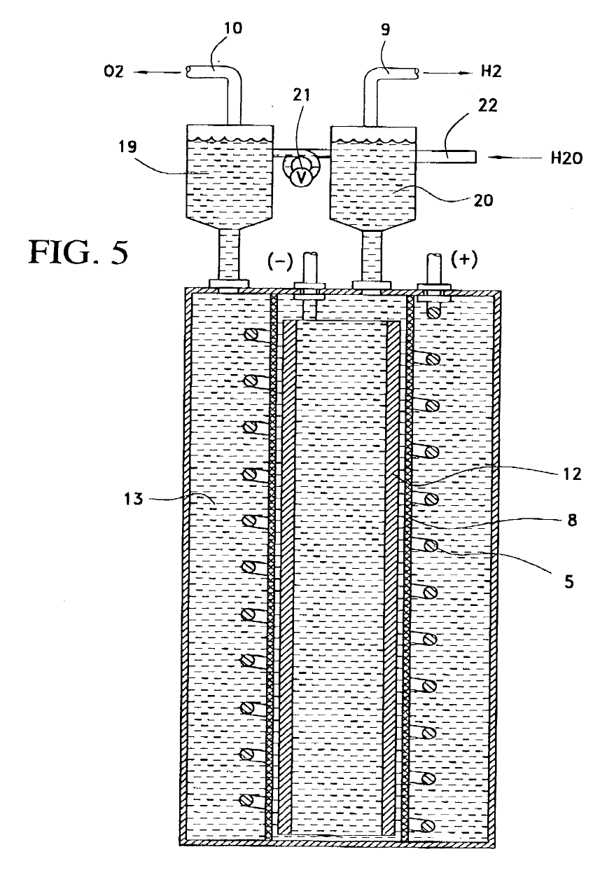

FIG. 5 shows a variation of the arrangement of FIGS. 1-3 in which the inner electrode is replaced by an electrically conductive cylinder 12, all other aspects of this embodiment being the same as that disclosed in FIG. 1.

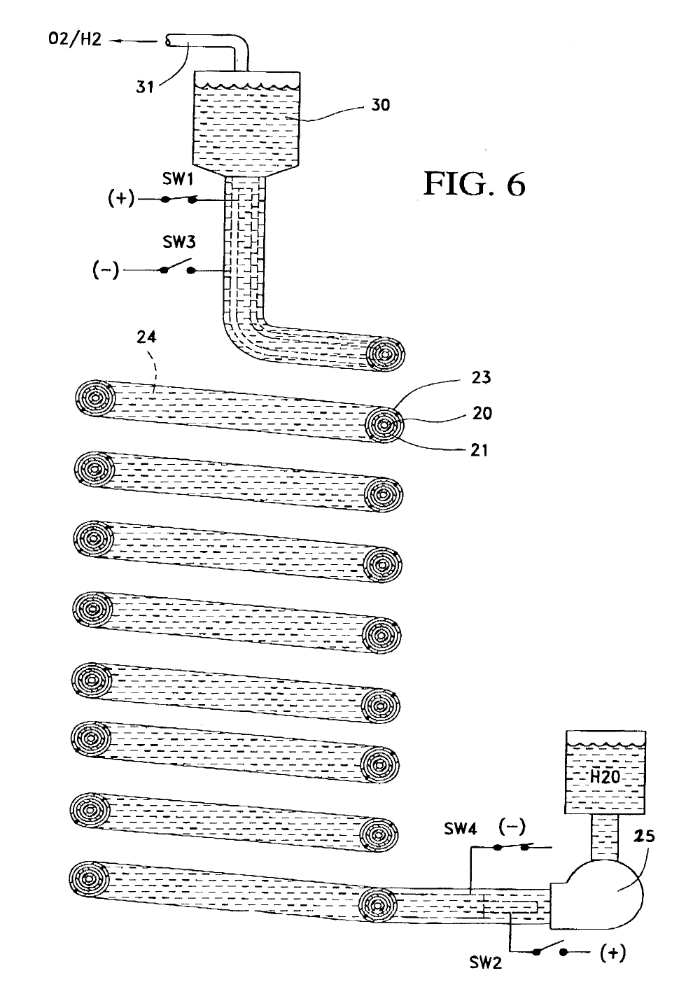

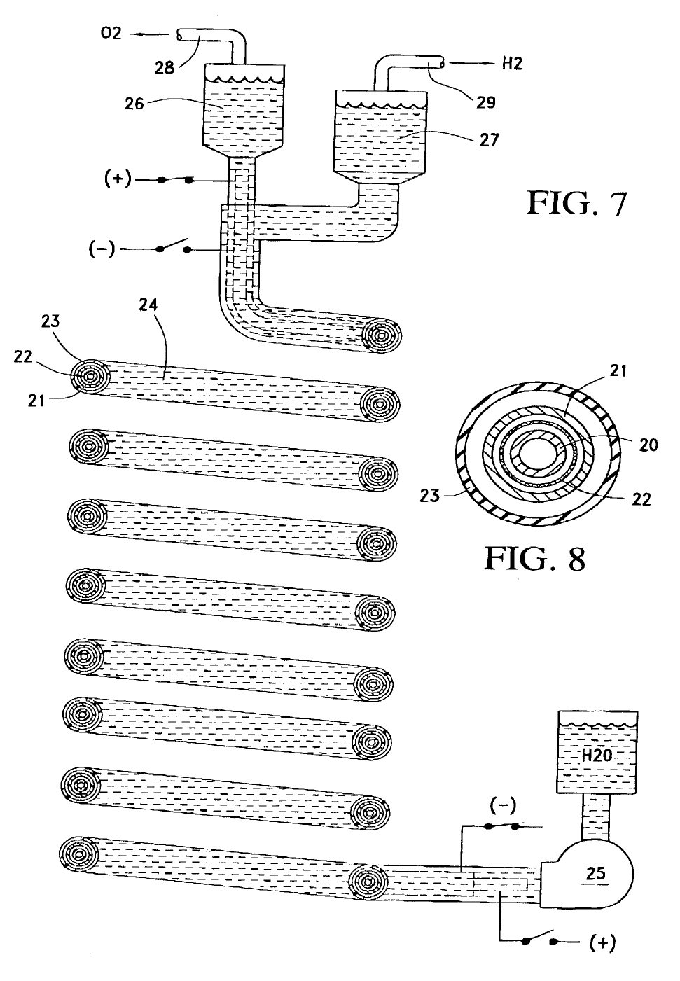

In the embodiment illustrated in FIGS. 6-8, the electrodes are in the form of coaxial cylindrical structures 20 and 21 separated by a membrane 22 and surrounding by a flexible hose or tube 23, which may be made, for example, of rubber or a flexible polymer material. The magnetic field generating coils are achieved by forming or bending the hose 23 into a helical coil shape. Water 24 is caused by a pump 25 to flow through hose 23 to outlet reservoirs 26 and 27, and respective oxygen and hydrogen outlets 28 and 29, shown in FIG. 7, or combined oxygen/hydrogen reservoir 30 and outlet 31, shown in FIG. 7.

Electrical connections to the electrodes 20 and 21 may be in the form of a conventional single-ended DC connection, a double-ended DC connection, a reversing DC connection controlled by switches SW1 to SW4, as discussed above, or any other connection arrangement capable of applying voltages to the electrodes that are suitable for carrying out electrolysis.

In the embodiments of FIGS. 6-8, the magnetic fields generated by the electrodes 20 and 21 may have the same direction or opposite directions, depending on whether the polarities of the applied voltages are the same or opposite. As illustrated, the polarities are opposite, which will result in magnetic fields that cancel. It is noted that the coiled hose also produces a magnetic field surrounding the coils that may oppose or reinforce the magnetic field within the coils. Multiple magnetic fields are thereby generated, one inside the anode, another one inside of the cathode, and another one inside the center of the coiled hose all switching in sync or out of sync if reversing DC voltages are applied, or constant if just a DC voltage is applied.

The method of the invention involves the steps of providing an electrolysis apparatus in which at least one of the electrodes 4,5 is a coil, and applying a DC voltage to the electrodes. The DC voltage may, as discussed above, be a constant voltage or may be alternately applied to opposite ends of the electrodes so as to cause reversal of currents in the electrodes, and therefore change in the direction of the current in the electrolyte.

Having thus described a preferred embodiment of the invention in sufficient detail to enable those skilled in the art to make and use the invention, it will nevertheless be appreciated that numerous variations and modifications of the illustrated embodiment may be made without departing from the spirit of the invention.

For example, although less suitable for electrolysis, it is within the scope of the invention to apply voltages other than those noted above to the apparatus of the preferred embodiment. These include pulsed DC, polarity-reversing DC, and conventional AC voltages, as well as direction-reversing AC voltages of the type described in copending U.S. patent application Ser. No. xxx,xxx, cited above. Where possible, it is also within the scope of the invention to apply the voltages to one end of the electrodes, although application to two ends is preferred since application to two ends reduces losses due to voltage drops within the electrodes.

In addition, it is possible to recirculate water in the outlet reservoir(s) at the top of the electrolytic cell back to the inlet reservoir or pump, the gases carried by the water into the outlet reservoir rising to the top of the reservoirs for capture.

Still further, it is possible to use coil arrangements of the type described above for purposes other than just generation of gases. For example, it has been found that when a coil is wrapped around the joint of a person, the resulting fields promote the growth of cartilage. The same fields may have numerous other applications, including coiled gas flow sensor applications such as described in Pat. No. 6,240,776, and the applications discussed in the above-cited copending application Ser. No. 10/xxx,xxx.

As a result, it is intended that the invention not be limited by the above description or accompanying drawings, but that it be defined solely in accordance with the appended claims.

I claim:

1. An electrolytic cell, comprising:
a housing containing an electrolytic medium;
at least two coaxial electrodes; and
means for applying a magnetic field to the electrolytic medium in a direction generally transverse to ionic currents in the medium when a voltage is applied to the electrodes.

2. An electrolytic cell as claimed in claim 1, wherein at least one of said electrodes forms a coil, and said means for applying the magnetic field is the coil.

3. An electrolytic cell as claimed in claim 2, wherein two of said coaxial electrodes form coils.

4. An electrolytic cell as claimed in claim 2, wherein said coils are wound in opposite directions.

5. An electrolytic cell as claimed in claim 2, wherein said coils are wound in a same direction.

6. An electrolytic cell as claimed in claim 1, wherein said voltage is an alternating DC current obtained by cyclically switching directions of a respective current in at least one of the electrodes.

7. An electrolytic cell as claimed in claim 6, wherein means for supplying said alternating direct current includes at least one power supply and circuitry connected between said at least one power supply and two ends of at least one of said electrodes for alternately supplying a current to respective said ends of said at least one of said electrodes in order to cause a cyclically reversing electrical current to flow within said electrode between said ends.

8. An electrolytic cell as claimed in claim 7, wherein said circuitry includes respective switches connected between a terminal of the power supply and each end of said at least one electrode, and wherein said switches are arranged to be alternately opened and closed.

9. An electrolytic cell as claimed in claim as claimed in claim 7, wherein said circuitry includes respective first switches connected between a terminal of said power supply and each end of said at least one of said electrodes, said first switches being arranged to be alternately opened and closed, and further comprising pairs of switches connected between said first switches and ground or opposite polarity terminals of said power supply.

10. An electrolytic cell as claimed in claim 1, further comprising means for encapsulating at least one of said electrodes in a material impervious to gas bubbles but conductive to electron flow.

11. An electrolytic cell as claimed in claim 10, wherein said membrane is sandwiched between at least two of said electrodes.

12. An electrolytic cell as claimed in claim 10, wherein at least one of said electrodes is a coil, and said membrane is a sleeve coiled substantially coextensively with respect to said at least one coil.

13. An electrolytic cell as claimed in claim 12, wherein water is pumped through said sleeve.

14. An electrolytic cell as claimed in claim 1, further comprising means for encapsulating at least one of said electrodes in a material electrochemically conductive to ion flow and non-porous to gas bubbles.

15. An electrolytic cell as claimed in claim 1, wherein said cell is arranged to permit photo-electrolysis in addition to electrolysis resulting from the application of DC voltages.

16. An electrolytic cell as claimed in claim 1, wherein said medium is water.

17. An electrolytic cell as claimed in claim 16, wherein said medium further includes a catalyst.

18. An electrolytic cell as claimed in claim 17, wherein said catalyst is potassium hydroxide.

19. An electrolytic cell as claimed in claim 1, wherein said voltage is a DC voltage.

20. An electrolytic cell as claimed in claim 1, wherein said voltage is applied to two ends of each electrode.

21. An electrolytic cell as claimed in claim 1, wherein said voltage is applied to one end of at least one of the electrodes.

22. An electrolytic cell, comprising:
a housing containing an electrolytic medium; and
at least two coaxial electrodes, wherein at least one of said electrodes forms a coil.

23. Apparatus as claimed in claim 22, wherein two of said coaxial electrodes form coils.

24. Apparatus as claimed in claim 22, wherein said coils are wound in opposite directions.

25. Apparatus as claimed in claim 22, wherein said coils are wound in a same direction.

26. Apparatus as claimed in claim 22, wherein said DC current is an alternating DC current obtained by cyclically switching directions of a respective current in at least one of the electrodes.

27. Apparatus as claimed in claim 26, wherein means for supplying said alternating direct current includes at least one power supply and circuitry connected between said at least one power supply and two ends of at least one of said electrodes for alternately supplying a current to respective said ends of said at least one of said electrodes in order to cause a cyclically reversing electrical current to flow within said electrode between said ends.

28. Apparatus as claimed in claim 27, wherein said circuitry includes respective switches connected between a terminal of the power supply and each end of said at least one electrode, and wherein said switches are arranged to be alternately opened and closed.

29. Apparatus as claimed in claim as claimed in claim 27, wherein said circuitry includes respective first switches connected between a terminal of said power supply and each end of said at least one of said electrodes, said first switches being arranged to be alternately opened and closed, and further comprising pairs of switches connected between said first switches and ground or opposite polarity terminals of said power supply.

30. Apparatus as claimed in claim 22, further comprising means for encapsulating at least one of said electrodes in a material impervious to gas bubbles but conductive to electron flow.

31. Apparatus as claimed in claim 22, further comprising means for encapsulating at least one of said electrodes in a material electrochemically conductive to ion flow and non-porous to gas bubbles.

32. Apparatus as claimed in claim 22, wherein said housing is arranged to permit photo electrolysis in addition to electrolysis resulting from the application of DC voltages.

33. Apparatus as claimed in claim 22, wherein said medium is water.

34. An electrolytic cell as claimed in claim 33, wherein said medium further includes a catalyst.

35. An electrolytic cell as claimed in claim 34, wherein said catalyst is potassium hydroxide.

36. An electrolytic cell as claimed in claim 22, wherein said voltage is a DC voltage.

37. An electrolytic cell as claimed in claim 22, wherein said voltage is applied to two ends of each electrode.

38. An electrolytic cell as claimed in claim 22, wherein said voltage is applied to one end of at least one of the electrodes.

39. An electrolytic cell as claimed in claim 22, further comprising means for encapsulating at least one of said electrodes in a material impervious to gas bubbles but conductive to electron flow.

40. An electrolytic cell as claimed in claim 39, wherein said membrane is sandwiched between at least two of said electrodes.

41. An electrolytic cell as claimed in claim 39, wherein said membrane is a sleeve coiled substantially coextensively with respect to said coil.

42. An electrolytic cell as claimed in claim 41, wherein water is pumped through said sleeve.

43. An electrolysis method, comprising the steps of:
providing at least two electrodes, wherein at least one of the two electrodes is a coil; and
generating a magnetic field in said coil by applying a DC voltage to said electrodes.

44. An electrolysis method as claimed in claim 43, further comprising the step of cyclically changing a direction of current between said electrodes by cyclically connecting and disconnecting opposite ends of at least one of the electrodes in order to reverse a direction of current within said at least one of the electrodes.

45. An electrolysis method as claimed in claim 43, wherein each of said two electrodes is a coils, and magnetic fields are generated in each of said coils.

46. An electrolytic cell, comprising:
a housing; and
at least two coaxial electrodes surrounded by said housing,
wherein said housing is a flexible tubular member having a coil shape.

47. An electrolytic cell as claimed in claim 46, further comprising a pump for pumping an electrolytic medium through said tubular member.

48. An electrolytic cell as claimed in claim 46, further comprising a pump at one end of said tubular member for pumping water through said tubular member, and at least one gas outlet at a second end of said tubular member for collecting oxygen, hydrogen, or oxygen and hydrogen.

49. An electrolytic cell as claimed in claim 46, further comprising a membrane conductive to currents or capable of exchanging ions, said membrane surrounding an inner one of said coaxial electrodes to prevent mixing of gases generated by anodic and cathodic reactions at the electrodes.
